(19) United States
(12) Patent Application Publication
(10) Pub. No.: US 2014/0147377 A1
(43) Pub. Date: May 29, 2014

(54) PHOTOCATALYST FOR WATER SPLITTING

(71) Applicants: Ghim Wei Ho, Singapore (SG); Kian Jon Chua, Singapore (SG)

(72) Inventors: Ghim Wei Ho, Singapore (SG); Kian Jon Chua, Singapore (SG)

(73) Assignee: NATIONAL UNIVERSITY OF SINGAPORE, Singapore (SG)

(21) Appl. No.: 14/233,048

(22) PCT Filed: Jul. 16, 2012
(86) PCT No.: PCT/SG2012/000253

§ 371 Date: Jan. 15, 2014

Related U.S. Application Data
(60) Provisional application No. 61/513,071, filed on Jul. 29, 2011.

(30) Foreign Application Priority Data
Jul. 15, 2011 (SG) 201105145.5

(51) Int. Cl. B01J 35/10; B01J 37/00; C01B 3/06

(52) U.S. Cl. CPC B01J 35/1038; C01B 3/06; B01J 37/00
USPC 423/658.2; 502/180; 502/300; 502/302; 428/402; 428/372; 502/100

(57) ABSTRACT

A nanocrystalline photocatalyst for water splitting and a method for fabricating a nanocrystalline photocatalyst for water splitting. The photocatalyst comprises a structure having a specific surface area and a volume fraction of atoms located both on the surface and at the grain boundaries adapted for enhancement of a photocatalytic reaction.

### FIELD OF INVENTION

The present invention broadly relates to a photocatalyst for water splitting and a method for fabricating a photocatalyst for water splitting, and more particularly relates to one-dimensional nanowires, two-dimensional nanosheets, three-dimensional gyroid structures, and similar structures for enhancing photocatalytic reactions.

### BACKGROUND

Photocatalytic water splitting is a technique for producing hydrogen that has attracted significant interest due to advantages such as simplicity, abundance of starting material and clean production, etc. Some key technical challenges in photocatalytic water splitting include the development of a stable (against photocorrosion) and visible light-responsive photocatalyst, and improvement of low system efficiency and high capital costs. These challenges have to be fundamentally resolved before large-scale sustainable and energy-efficient hydrogen production can be realised.

It is appreciated that the photocatalyst technology is a main factor that determines the efficiency of solar energy to chemical energy conversion for hydrogen (H₂) production by water splitting. The uphill thermodynamic potential for water splitting requires a minimum energy of 1.23 electron volts (eV) per photon. About 70% of all solar photons are theorectically available for water splitting. However, there is a technical challenge of energy losses associated with solar energy conversion using a photocatalyst. Such losses may occur due to the transport of electrons/holes from the position of their generation at the near-surface outward to the photocatalyst-water interface, and/or recombination of photogenerated electron-hole pairs.

There have been attempts at developing photocatalysts for water splitting. However, due to stringent requirements such as thermodynamic potential, bandgap and stability against photocorrosion, the number of reliable photocatalysts suitable for efficient water splitting is limited. For example, most of the conventional photocatalysts are ultra violet (UV)-light responsive, and they are typically unstable when coming into contact with electrolytes. Also, UV light accounts only 3-4% of available solar radiation energy, making such photocatalysts inefficient. Moreover, the conventional photocatalysts are mainly spherical nanoparticles or micropowders which have somewhat limited chemical reactivity, light scattering, surface area, light absorption spectrum and recombination suppression properties.

Thus, there exists a need to provide a photocatalyst for water splitting that seeks to combine electronic, optical and corrosion properties.

### SUMMARY

In accordance with a first aspect of the present invention, there is provided a photocatalyst for water splitting, the photocatalyst comprising a nanocrystalline structure having a selected specific surface area and volume fraction of atoms located both on the surface and at the grain boundaries to provide an increase in the surface energy for enhancement of a photocatalytic reaction relative to spherical nanoparticles and/or zero-dimensional nanoparticles.

The selected nanocrystalline structure excludes spherical nanoparticles and zero-dimensional nanoparticles.

The photocatalyst may comprise a structure selected from the group consisting of

a structure comprising one or more one-dimensional nanowires,
a lamellar structure comprising two-dimensional nanosheets, and
a structure comprising a three-dimensional gyroid structure.

The photocatalyst may have a specific surface area of greater than 70 m²/g, a pore volume of greater than 0.04 cm³/g, and a H₂ production capability of greater than 250 μmolh⁻¹g⁻¹.

The photocatalyst may exhibit an improvement in light absorption of at least 40% over spherical nanoparticles and/or zero-dimensional nanoparticles and an improvement in photocatalytic performance of at least 2 times over spherical nanoparticles and/or zero-dimensional nanoparticles.

The photocatalyst may comprise a structure having a larger specific surface area and a higher volume fraction of atoms located both on the surface and at the grain boundaries compared to a spherical nanoparticle. Spherical nanoparticle photocatalysts and/or zero-dimensional nanoparticle photocatalysts have a specific surface area of 50 m²/g to 70 m²/g. The photocatalysts of the present invention may have a specific surface area of at least about 80 m²/g.

In one embodiment, the structure comprises one or more one-dimensional nanowires, wherein the structure may comprise a plurality of one-dimensional nanowires. The one-dimensional nanowires may have a specific surface area of at least about 80 m²/g. In one embodiment, the one-dimensional nanowires may have a specific surface area of about 80 m²/g to about 150 m²/g.

Functionalized nanoparticles may be disposed on the one-dimensional nanowires.

Functionalized branches may be disposed on the one-dimensional nanowires.

In another embodiment, the structure comprises a lamellar structure comprising two-dimensional nanosheets, wherein the lamellar structure may comprise two-dimensional nanosheets intercalated with nanoparticles or nanorods. The two-dimensional nanosheet lamellar structure may have a specific surface area of at least about 150 m²/g. In one embodiment, the two-dimensional nanosheet lamellar structure may have a specific surface area of about 150 m²/g to about 280 m²/g.

The nanosheets may comprise a metal oxide or graphene.

In another embodiment, the structure comprises a three-dimensional gyroid structure. The three-dimensional gyroid structure may have a specific surface area of at least about 250 m²/g. In one embodiment, the three-dimensional gyroid structure may have a specific surface area of about 250 m²/g to about 500 m²/g.

The photocatalyst may be further configured to receive a co-catalyst for enhancement of the photocatalytic reaction.

The co-catalyst may comprise nanoparticles or nanorods.

The co-catalyst may comprise a core-shell structure comprising a lanthanide/transition metal core and a metal oxide shell. The transition metal may comprise nickel (Ni), copper (Cu), molybdenum (Mo), silver (Ag), platinum (Pt), or gold (Au). Other transition metals are also contemplated. The lanthanide metal may comprise cerium (Ce), erbium (Er), or europium (Eu). Other lanthanide metals are also contemplated.

In accordance with a second aspect of the present invention, there is provided a method for fabricating a photocatalyst for water splitting, the method comprising the step of forming a nanocrystalline structure having a selected specific surface area and volume fraction of atoms located both on the surface and at the grain boundaries to provide an increase in the surface energy for enhancement of a photocatalytic reaction relative to spherical nanoparticles and/or zero-dimensional nanoparticles.

The method may comprise forming a structure selected from the group consisting of

a structure comprising one or more one-dimensional nanowires,
a lamellar structure comprising two-dimensional nanosheets, and
a structure comprising a three-dimensional gyroid structure,
and wherein the photocatalyst has a specific surface area of greater than 70 m²/g, has a pore volume of greater than 0.04 cm³/g, and has a H₂ production capability of greater than 250 μmolh⁻¹g⁻¹,
thereby exhibiting an improvement in light absorption of at least 40% over spherical nanoparticles and/or zero-dimensional nanoparticles and an improvement in photocatalytic performance of at least 2 times over spherical nanoparticles and/or zero-dimensional nanoparticles.

The method may comprise forming the structure having a larger specific surface area and/or a high volume fraction of atoms located both on the surface and at the grain boundaries of the photocatalyst compared to a spherical nanoparticle.

In one embodiment, the structure formed comprises one or more one-dimensional nanowires, and the method further comprises forming the structure comprising one or more one-dimensional nanowires to comprise a plurality of one-dimensional nanowires.

The one-dimensional nanowires may be formed using a hydrothermal growth process.

The method may further comprise disposing functionalized nanoparticles on the one-dimensional nanowires.

The method may further comprise disposing functionalized nanoparticles on the one-dimensional nanowires, wherein the functionalized nanoparticles are disposed on the one-dimensional nanowires by sputtering of a film and performing a dewetting process.

The method may further comprise disposing functionalized branches on the one-dimensional nanowires.

The method may further comprise disposing functionalized branches on the one-dimensional nanowires, wherein the functionalized branches are disposed on the one-dimensional nanowires by spin coating of colloidal nanoparticles and performing a hydrothermal growth process.

In another embodiment, the structure formed comprises a lamellar structure comprising two-dimensional nanosheets, and the method further comprises forming the lamellar structure to comprise a lamellar structure comprising two-dimensional nanosheets intercalated with nanoparticles or nanorods.

The method may comprise forming the structure to comprise the lamellar structure defined above, wherein a precursor of the nanoparticles is set at about 90-100° C. for the intercalation with the nanoparticles, and wherein a concentration of about 5.5 mmol or greater of metal acetate dihydrate is provided for the intercalation with the nanorods.

The nanosheets may comprise a metal oxide or graphene.

The metal oxide nanosheet may be synthesized using a hydrothermal process to form a colloidal suspension, and the graphene nanosheet may be synthesized from graphite powder using the Hummers method to form a colloidal suspension.

In another embodiment, the structure formed comprises a three-dimensional gyroid structure.

The gyroid structure may be formed by a process comprising mixing inorganic metal oxide precursors with a structure-directing agent.

The method may further comprise adapting the photocatalyst to receive a co-catalyst for enhancement of the photocatalytic reaction.

The co-catalyst may comprise nanoparticles or nanorods.

The co-catalyst may comprise a core-shell structure comprising a lanthanide/transition metal core and a metal oxide shell.

The core-shell co-catalyst may be synthesized using precipitation and a hydrothermal process.

In accordance with a third aspect of the present invention, there is provided a water splitting method comprising using the photocatalyst as defined in the first aspect.

### DEFINITIONS

Unless specified otherwise, the terms “comprising” and “comprise”, and grammatical variants thereof, are intended to represent “open” or “inclusive” language such that they include recited elements but also permit inclusion of additional, un-recited elements.

As used herein, the term “about”, in the context of technical values such as technical values related to specific surface area, H₂ production or H₂ evolution, light absorption, pore size, and pore volume typically means +/−5% of the stated value, more typically +/−4% of the stated value, more typically +/−3% of the stated value, more typically, +/−2% of the stated value, even more typically +/−1% of the stated value, even more typically +/−0.5% of the stated value, and even more typically +/−0% of the stated value.

Throughout this disclosure, certain embodiments may be disclosed in a range format. It should be understood that the description in range format is merely for convenience and brevity and should not be construed as an inflexible limitation on the scope of the disclosed ranges. Accordingly, the description of a range should be considered to have specifically disclosed all the possible sub-ranges as well as individual numerical values within that range. For example, description of a range such as from 1 to 6 should be considered to have specifically disclosed sub-ranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

### BRIEF DESCRIPTION OF THE DRAWINGS

Embodiments of the invention will be better understood and readily apparent to one of ordinary skill in the art from the following written description, by way of example only, and in conjunction with the drawings, in which:

FIG. 1(a) shows a schematic diagram illustrating possible recombination when a metal core is deposited on a photocatalyst.

FIG. 1(b) shows a schematic diagram illustrating H₂ evolution and prevention of recombination using the co-catalyst according to an example embodiment.

FIG. 1(c) shows a magnified view of a core-shell structure comprising a transition metal core and a metal oxide shell according to an example embodiment.

FIG. 2(a) shows a microscopic image of one-dimensional (1D) nanowires comprising functionalized nanoparticles disposed thereon according to an example embodiment.

FIG. 2(b) shows an enlarged view of FIG. 2(c).

FIG. 2(c) shows a microscopic image of one-dimensional (1D) nanowires comprising functionalized branches disposed thereon according to an example embodiment.

FIG. 2(d) shows an enlarged view of FIG. 2(a).

FIG. 2(e) shows a schematic diagram illustrating the improvement using the 1D nanowires of FIG. 2(a).

FIG. 2(f) shows a schematic diagram illustrating the improvement using the 1D nanowires of FIG. 2(c).

FIG. 3(a) shows an illustration of 2D catalyst-mat supports with intercalated nanoparticles according to an example embodiment.

FIG. 3(b) shows a schematic diagram providing an alternate illustration to that in FIG. 3(a).

FIGS. 4(a)-(b) show scanning electron microscope (SEM) images of example 2D lamellar systems and intercalation of nanorods and nanoparticles according to an example embodiment.

FIG. 5(a) shows an illustration of a typical discontinuous three-dimensional matrix.

FIG. 5(b) shows an illustration of a three-dimensional gyroid structure according to an example embodiment.

FIGS. 6(a)-(c) show scanning electron microscope (SEM) images of a mesoporous film with different added % volume fractions of a block copolymer (BCP) to tune the surface morphology according to an example embodiment.

FIG. 6(d) shows a cross sectional SEM image of the mesoporous film of FIG. 6(a).

FIG. 7 shows the photocatalytic H₂ evolution and/or H₂ production of surface engineered one-dimensional nanowires, two-dimensional nanosheets, and three-dimensional gyroids compared with the photocatalytic H₂ evolution of zero-dimensional nanoparticles and/or spherical nanoparticles.

FIG. 8 shows the photocatalytic H₂ evolution and/or H₂ production of various co-catalysts combined with a spherical photocatalyst compared with the photocatalytic H₂ evolution of a spherical photocatalyst without a co-catalyst.

FIG. 9 shows TEM images of a copper (Cu) core-shell co-catalyst and nickel (Ni) core-shell co-catalyst.

FIG. 10 shows the enhanced visible light scattering capability of one-dimensional nanowires comprising branches for improved photon harvesting and/or improved visible light absorption.

### DETAILED DESCRIPTION

The inventors have observed that a nanocrystalline photocatalyst with surface engineering for large specific surface area and high volume fraction of atoms located both on the surface and at the grain boundaries possesses high photocatalytic efficiency because of the unique properties conferred by its very small physical dimensions. The large specific surface area and high volume fraction of atoms located both on the surface and at the grain boundaries may result in an increased surface energy. As such, the nanocrystalline photocatalyst can provide an increase in the number of active catalytic sites. Therefore, in some example embodiments, nanocrystalline photocatalysts with a hierarchical structural network are used because light absorption can be improved due to the enlarged surface area and multiple light scattering within the porous matrix. They can also facilitate better accessibility of reactants, leading to the enhancement of photocatalytic reactions.

Spherical nanoparticle photocatalysts and/or zero-dimensional nanoparticle photocatalysts have a photocatalytic efficiency and/or H₂ production capability of 250 μmolh⁻¹g⁻¹. The photocatalysts of the present invention may have a photocatalytic efficiency and/or H₂ production capability of greater than 250 μmolh⁻¹g⁻¹.

The one-dimensional nanowires of the present invention may have a photocatalytic efficiency and/or H₂ production capability of about 500 μmolh⁻¹g⁻¹. The two-dimensional nanosheet lamellar structure photocatalysts of the present invention may have a photocatalytic efficiency and/or H₂ production capability of about 560 μmolh⁻¹g⁻¹ to about 800 μmolh⁻¹g⁻¹. The three-dimensional gyroids of the present invention may have a photocatalytic efficiency and/or H₂ production capability of greater than 800 μmolh⁻¹g⁻¹. When the one-dimensional nanowire photocatalysts, two-dimensional nanosheet lamellar structure photocatalysts, and three-dimensional gyroid photocatalysts of the present invention are modified to include co-catalysts, the photocatalysts may have a photocatalytic efficiency and/or H₂ production capability of up to about 7000 μmolh⁻¹g⁻¹.

Spherical nanoparticle photocatalysts and/or zero-dimensional nanoparticle photocatalysts have a specific surface area of 50 m²/g to 70 m²/g. The photocatalysts of the present invention may have a specific surface area of at least about 80 m²/g.

The one-dimensional nanowires may have a specific surface area of at least about 80 m²/g. In one embodiment, the one-dimensional nanowires may have a specific surface area of about 80 m²/g to about 150 m²/g.

The two-dimensional nanosheet lamellar structure may have a specific surface area of at least about 150 m²/g. In one embodiment, the two-dimensional nanosheet lamellar structure may have a specific surface area of about 150 m²/g to about 280 m²/g.

The three-dimensional gyroid structure may have a specific surface area of at least about 250 m²/g. In one embodiment, the three-dimensional gyroid structure may have a specific surface area of about 250 m²/g to about 500 m²/g.

Additionally, the one-dimensional nanowire photocatalysts, two-dimensional nanosheet lamellar structure photocatalysts, and three-dimensional gyroid photocatalysts of the present invention may exhibit an improvement in light absorption of about 40% to about 80% over spherical nanoparticle photocatalysts and/or zero-dimensional nanoparticle photocatalysts.

As will be appreciated by a person skilled in the art, the specific surface area may refer to the total surface area per unit mass or volume. Stated differently, the specific surface area of an object may be the total surface area of the object divided by the mass or volume of the object. Additionally, the volume fraction of atoms located both on the surface and at the grain boundaries may refer to the volume of the atoms at those areas divided by the volume of the photocatalyst.

Also, a photocatalyst normally requires loading and doping of foreign particles as co-catalysts for high activity and reaction rates. Other than reducing the activation energy, a co-catalyst can provide the means for charge and site separation during the gas evolution. For example, a co-catalyst improves the efficiency of the photocatalyst as a result of the capture of conduction band (CB) electrons or valence band (VB) holes from the photocatalyst, thereby reducing the possibility of electron-hole recombination; and the transference of electrons and holes to surface water molecules, thereby reducing the activation energy for the reduction/oxidation of water. The activity of a co-catalyst is found to be strongly dependent on the quantity of the co-catalyst deposited on the photocatalyst surface. When the amount exceeds a critical limit, the co-catalysts act as electron-hole recombination centres, reducing the efficiency of the host photocatalyst. In the example embodiments, in addition to adding in carbonate, nitrate salts to suppress the backward reaction, the material and structural architecture of the co-catalyst are configured to enhance the water splitting effect. Preferably, a systematic optimization of the percentage by weight (wt %) of the co-catalyst is carried out to determine the most suitable amount, as the optimal amount to be added in is different based on the photocatalyst materials. Typically, the amount of the co-catalyst is about 0.5 to 2 wt %. For example, the amount of nickel (Ni) co-catalyst for AgGa₂O₃ is 1.54 wt %.

In one example embodiment, zero-dimensional (0D) transition metal nanoparticles are used as the co-catalyst. Additionally, for the structural architecture of the co-catalyst, a core-shell structure is used. For example, the co-catalyst comprises a metal oxide as the passivating shell and a transition metal as the core. Metal oxides are found to be an effective shell material as an oxygen diffusion barrier, to prevent oxygen from diffusing through the evolution site and recombining with evolved H₂. The transition metal core acts as a site for H₂ evolution due to their reducing properties. In an example implementation, the core-shell nanoparticles are precipitated onto the host photocatalyst material, for acting as a co-catalyst. As an alternative to the transition metal, a lanthanide element can be used as the core material of the core-shell structures.

The transition metal may comprise nickel (Ni), copper (Cu), molybdenum (Mo), silver (Ag), platinum (Pt), or gold (Au). Other transition metals are also contemplated. The lanthanide metal may comprise cerium (Ce), erbium (Er), or europium (Eu). Other lanthanide metals are also contemplated.

The co-catalyst may comprise a Ni—NiO core-shell co-catalyst, Cu—Cu₂O core-shell co-catalyst, Cu—CuO core-shell co-catalyst, or Ag—TiO₂ core-shell co-catalyst. In the examples immediately described above, the co-catalyst comprises a transition metal as the core and a metal oxide as the shell. Other co-catalysts are also contemplated.

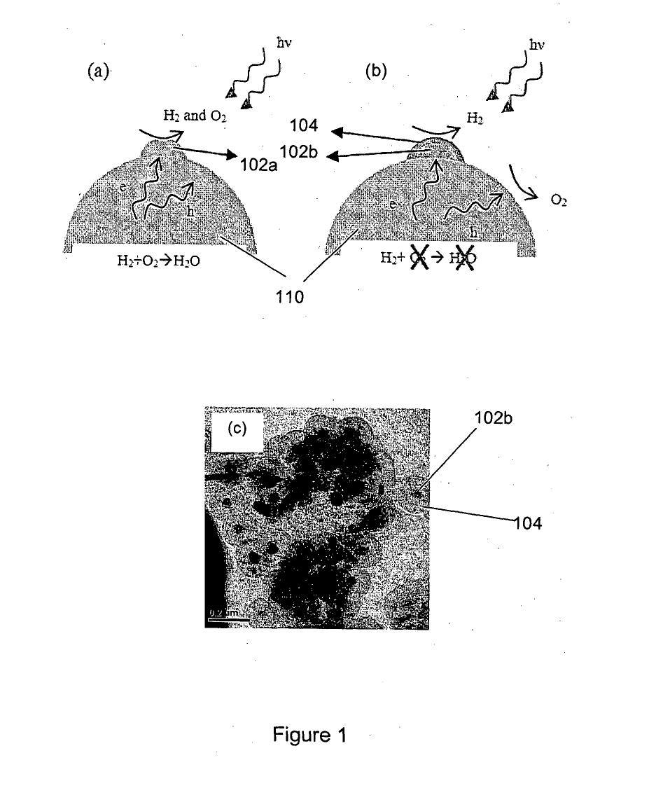

FIG. 1(a) shows a schematic diagram illustrating possible recombination when a metal core 102a is deposited on a photocatalyst 110. FIG. 1(b) shows a schematic diagram illustrating H₂ evolution and prevention of recombination using a co-catalyst according to an example embodiment. FIG. 1(c) shows a magnified view of a core-shell structure comprising a transition metal core 102b (e.g. in the form of a nanoparticle) and a metal oxide shell 104 according to an example embodiment.

With reference to FIGS. 1(b) and 1(c), when loaded lanthanide/transition metal nanoparticles 102b are covered with the metal oxide 104, the deactivation and the resulting O₂ photo-reduction is suppressed by the reduced accessibility of the reactants to the loaded metal/lanthanide core 102b. Thus, the core-shell structure according to the example embodiment can suppress water formation from H₂ and O₂, thereby allowing the forward reaction (i.e. water splitting) to take place.

In one example, the core-shell particles are synthesized using precipitation and a hydrothermal process. In an example preparation of gold (Au) nanoparticles, 0.25 millilitres (ml) of the 0.01 Mol (M) HAuCl₄.3H₂O is added to 7.5 ml of the 0.1M Cetyl trimethylammonium bromide (CTAB). The mixture is gently shaken to give brownish yellow solution. Then 0.6 ml of the freshly prepared 0.01M NaBH₄ is added into the solution, followed by mixing for at least 2 minutes. The solution changes to pale brown colour after mixing. Then a 0.03M TiF₄ solution is added to the mixture and with 90 ml of deionized (DI) water. The mixture is transferred to Teflon-lined stainless steel autoclaves where a hydrothermal reaction is performed at about 180-200° C. for about 24 hours (h). The precipitation is then washed with distilled water. The cycles of separation and washing are repeated 3 times in this example. The final samples are dried in an oven and collected. The above process results in the formation of a Au—TiO₂ core-shell co-catalyst.

Factors that may affect the net photocatalytic activity in the example embodiment include e.g. crystallographic phase, physical and chemical uniformity, mono dispersivity, shell thickness and dimension, as well as light adsorption and electronic properties.

Example embodiments of the present invention provide a nanocrystalline photocatalyst for water splitting. The photocatalyst assists in the processes involved in water splitting, e.g. generation and transfer of charges, suppression of charge recombination, etc. In preferred embodiments, the photocatalyst may comprise a structure having a specific surface area and a volume fraction of atoms located both on the surface and at the grain boundaries adapted for enhancement of a photocatalytic reaction. For example, the specific surface area and the volume fraction of atoms located both on the surface and at the grain boundaries may be greater compared to those of a spherical nanoparticle. The specific surface area may refer to the total surface area per unit mass or volume, while the volume fraction of atoms may refer to the volume of those atoms over the volume of the catalyst. The specific surface area and volume fraction of atoms may be modified by, among other things, changing the size and shape, surface engineering, doping, etc. Some example approaches may be described below.

In one example embodiment, the structure of the photocatalyst is configured to comprise one-dimensional (1D) composite nanowires. 1D nanowires have useful properties such as a lack of surface boundaries for better charge transfer, and an increased surface area for enhanced optical absorption properties. As photocatalysts active under visible light are not necessarily limited to semiconductors with a narrow band gap or modified bandgap, the photocatalyst in the example embodiment comprises semiconductors with a large band gap that can work synergetically with nanoparticles of a noble metal. Noble metal nanoparticles exhibit unique optical properties that arise from the collective oscillation of the conduction electrons upon interaction with electromagnetic radiation, namely, the localized surface plasmon resonance (SPR). SPR can significantly amplify the visible light absorption and boost the excitation of electron-hole pairs to produce efficient visible-light responsive photocatalysts in the example embodiment.

The semiconductor with a large band gap may comprise TiO₂ (hydrogenated), ZnO (nitrogenated), or WO₃. Other semiconductors are also contemplated.

The noble metal may comprise gold (Au) or silver (Ag). Other noble metals are also contemplated.

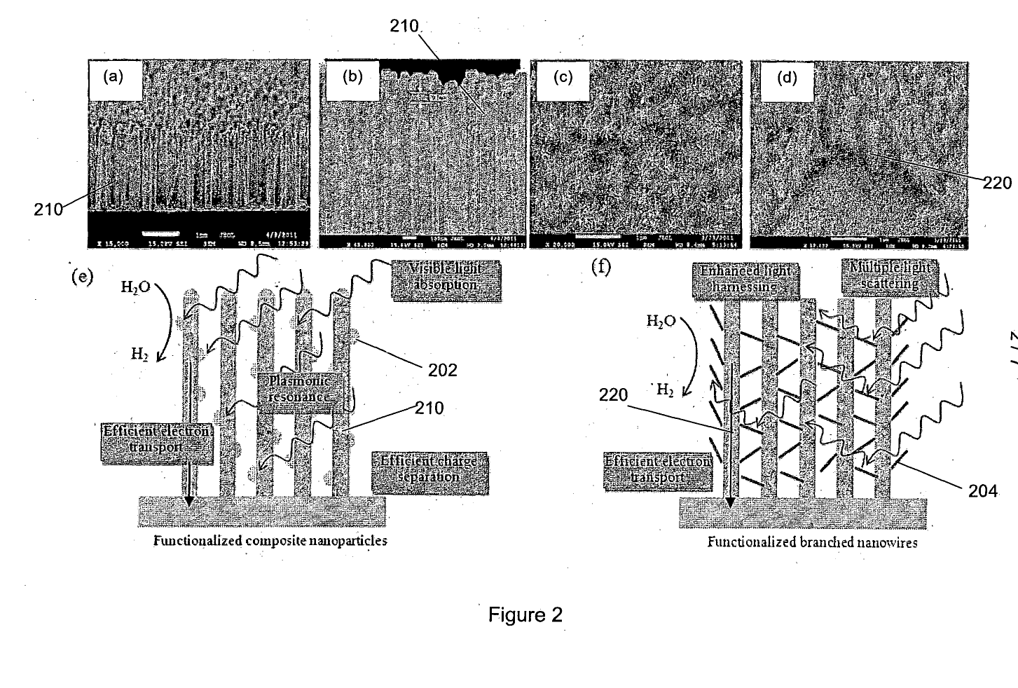

The 1D nanowires in the example embodiment are modified to enhance the photocatalytic performance by introducing e.g. plasmonic nanoparticles for enhanced light harvesting (as shown in FIGS. 2(a), 2(b) and 2(e)), and/or co-catalyst nanoparticles for H₂ gas evolution sites and electron trap aiding in electron-hole separation (not shown), and/or branched nanowires for enhanced light scattering and absorption (as shown in FIGS. 2(c), 2(d) and 2(f)). For example, with reference to FIGS. 2(a), 2(b) and 2(e), the 1D nanowires 210 comprise functionalized nanoparticles 202 disposed thereon for creating plasmonic resonance, thus improving visible light absorption. On the other hand, the nanowires 220 in FIGS. 2(c), 2(d) and 2(f) comprise functionalized branches 204 for improving visible light scattering and harvesting.

In one example, the 1D nanowires 210, 220 can be formed by hydrothermal growth. The functionalized nanoparticles 202 can be loaded onto the nanowires 210 by sputtering of an Au/Ag film and then performing a dewetting process. The functionalized branches 204 of the nanowires 220 can be grown by spin coating of colloidal nanoparticles and then performing hydrothermal growth. The functionalized branches may also comprise gold (Au) or silver (Ag).

In another embodiment, a two-dimensional (2D) nanomaterial, e.g. in the form of a lamellar structure, is used as a 2D catalyst mat (comprising graphene or metal oxide nanosheets) for designing the photocatalyst. Such 2D nanomaterial typically has excellent conductivity and mechanical strength, as well as suitable redox properties. The metal oxide may comprise an oxide of titanium (Ti), zinc (Zn), tungsten (W), or iron (Fe). Other metal oxides are also contemplated.

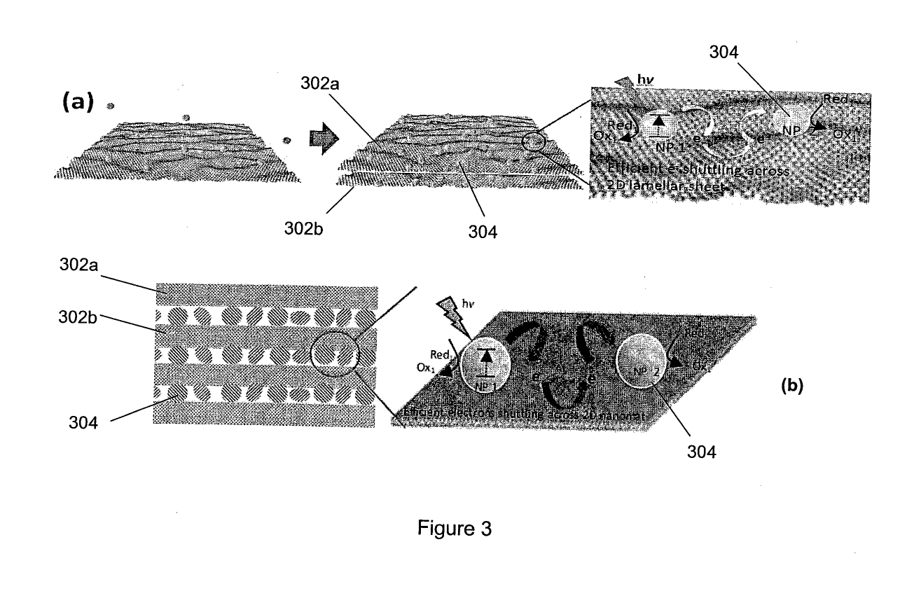

FIG. 3(a) shows an illustration of 2D catalyst-mat supports 302a, 302b with intercalated nanoparticles 304 according to an example embodiment. FIG. 3(b) shows a schematic diagram providing an alternate illustration to that in FIG. 3(a). It can be seen in FIGS. 3(a) and 3(b) that the support layers 302a, 302b, etc. and the intercalated nanoparticles 304 form a lamellar structure.

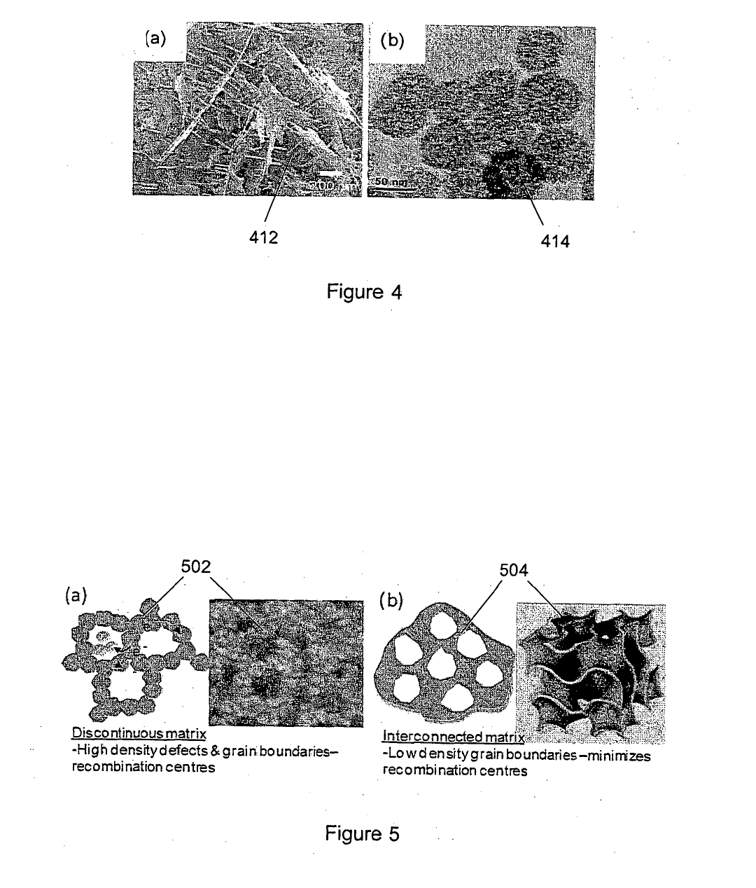

FIGS. 4(a)-(b) show scanning electron microscope (SEM) images of example 2D lamellar systems and intercalation of nanorods 412 and nanoparticles 414 according to an example embodiment.

In an example, the 2D catalyst mat comprising graphene or graphite oxide is synthesized from graphite powder by the Hummers' method, and the metal oxide nanosheet is synthesized by the hydrothermal method to form a colloidal suspension. The resultant colloidal solution of the 2D nanosheet is then transferred to a Teflon-lined stainless steel autoclave with the precursor of nanoparticles and maintained at predetermined growth conditions.

For example, 0.34 g of a metal oxide nanopowder is added to 20 ml of a 10M NaOH aqueous solution and mixed well. The solution is then heated to about 200° C. in a Teflon-lined autoclave for about 2 days. The cooled product is washed thoroughly. This is done in the example embodiment by adding DI water to the sample, centrifuging and then decanting the liquid several times. The white precipitate is then left to dry before immersing in 10 ml of a 0.1M aqueous solution of HCl for a duration of about 24 to 72 h. The product is then washed thoroughly and annealed at temperatures of between about 250 and 500° C. in a ceramic crucible for about 1 h. The metal oxide nanosheet is then mixed with metal acetate dihydrate (3.35 mmol for nanoparticles), potassium hydroxide and methanol solvent. The precursor of the nanoparticles is then set at about 90-100° C. for intercalation of the nanoparticles. The formation of nanorod intercalation is achieved at a higher concentration of metal acetate dihydrate (5.5 mmol). The solid products are collected by filtering through and washing with distilled water before drying, for forming the photocatalyst. The nanoparticles and nanorods are made from TiO₂ or ZnO. Other metal oxides for making the nanoparticles and nanorods are also contemplated.

The 2D lamellar nanomaterial system of the example embodiment may possess high specific surface areas, which make it suitable for use as a two-dimensional (2-D) catalyst support. In addition, it has the ability to store and shuttle electrons, via stepwise electron transfer process, and is highly efficient in the generation and collection of electrons. Preferably, the suspension-based functionalized 2D lamellar system can provide a rational route to retain an open network of 2D nanosheets, available for nanoparticle or nanorods intercalation.

In another embodiment, the morphology of the photocatalyst is configured to form three-dimensional (3D) gyroids. The gyroid structure is a suitable morphology because of its unique geometry, comprising a matrix of two continuous but independent, interpenetrating networks in three-dimensional space. In an example, after a selective degeneration of the minority block, the gyroid nanostructure is used to provide mono-disperse pore diameters in which all channels and structures are fully interconnected. The network with pores can be tuned to add in functionalized nanoparticles as co-catalyst. Because the gyroid structure has high porosity, a large specific surface area, high crystallinity, and well-defined pores, the gyroid structure can function as an effective catalyst in the example embodiment, e.g. by increasing the mass transfer of gases.

In one embodiment, the three-dimensional gyroid may have a pore size of about 7 nm to about 10 nm with a narrow pore size distribution. In comparison, zero-dimensional nanoparticles and/or spherical nanoparticles have a pore size of 10-50 nm.

In another embodiment, the three-dimensional gyroid may have a specific surface area of about 250 m²/g to about 500 m²/g. Additionally, the three-dimensional gyroid may comprise a polycrystalline anatase phase. As such, when using x-ray diffraction, sharp peaks show the high crystallinity of the three-dimensional gyroid having a polycrystalline anatase phase.

In an example, various surfactants such as E017-P012-C14, (EO)₂₀(PO)₇₀(EO)₂₀ and (PS-b-PEO) can be used as structure-directing agents for the highly organized gyroids. Different surfactants and added volume fraction result in the formation of different pore sizes, typically about 10-50 nanometers (nm). For example, hydrochloric acid, ethanol solvent and inorganic metal oxide precursors are mixed with the surfactant and magnetically stirred for approximately 10 minutes. The inorganic metal oxide precursor may comprises an oxide of titanium (Ti), tin (Sn), or zinc (Zn). Other inorganic metal oxide precursors are also contemplated. The mixture is then aged at about 13° C. for about 48 hours in a chiller. Subsequently, glass substrates are dip coated with dipping and withdrawing speed of about 60 mm/min. The samples are then aged at about 13° C. for about 48 hrs in a chiller and subsequently calcined with a heating rate of about 1° C./min to remove the surfactant and densify/crystalline the metal oxide gyroids.

FIG. 5(a) shows an illustration of a typical discontinuous three-dimensional matrix 502 where the high density of defects and grain boundaries can increase the number of recombination centres. In contrast, FIG. 5(b) shows an illustration of a three-dimensional gyroid structure 504, i.e. an interconnected matrix, according to an example embodiment where the low density of grain boundaries can minimize the number of recombination centres.

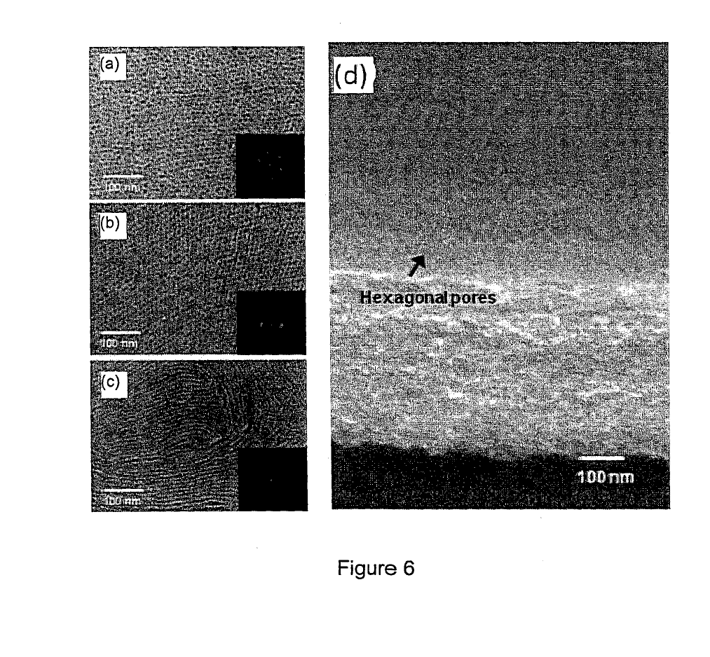

FIGS. 6(a)-(c) show scanning electron microscope (SEM) images of a mesoporous film with different added % volume fractions of a block copolymer (BCP) to tune the surface morphology according to an example embodiment. FIG. 6(d) shows a cross sectional SEM image of the mesoporous film of FIG. 6(a).

The example embodiments provide a photocatalyst which can offer unique features including a large specific surface area with different compositions and novel properties; an open porosity with hierarchical pore structures that can increase mass transport and allow fast access of reactive gases/liquids; highly periodic nanostructures which can provide a narrow distribution of surface reactivity properties; an intertwinned highly crystalline hierachical framework that can minimize surface and volume electron hole recombination reaction; and multiple light scattering within the hierarchical porous structure.

Spherical nanoparticle photocatalysts and/or zero-dimensional nanoparticle photocatalysts have a pore volume of 0.04 cm³/g. The one-dimensional nanowire photocatalysts, two-dimensional nanosheet lamellar structure photocatalysts, and three-dimensional gyroid photocatalysts of the present invention may have a pore volume of about 0.12 cm³/g to about 1.08 cm³/g.

To measure the distribution of surface reactivity of the photocatalysts of the present invention, the photoreactivity of a sample comprising a photocatalyst of the present invention was measured ten (10) times. Using this method of measurement, it was determined that the photocatalysts of the present invention showed a narrow range of photoreactivity thereby indicating a narrow distribution of surface reactivity.

The following method was used to measure the photocatalytic performance of the photocatalysts of the present invention. 0.3 g of photocatalyst was added to 100 ml of water in a quartz tube to form a reaction mixture. The reaction mixture was purged with Argon gas for 30 minutes before carrying out reaction. The reaction mixture was illuminated with a 300 W Xe lamp (Excelitas, PE300BFM). 100 μl of gas sample was drawn from the quartz tube using a syringe at about a 0.5-1 hr interval to sample the gas composition using a gas chromatographer (Shimadzu, GC-2014AT).

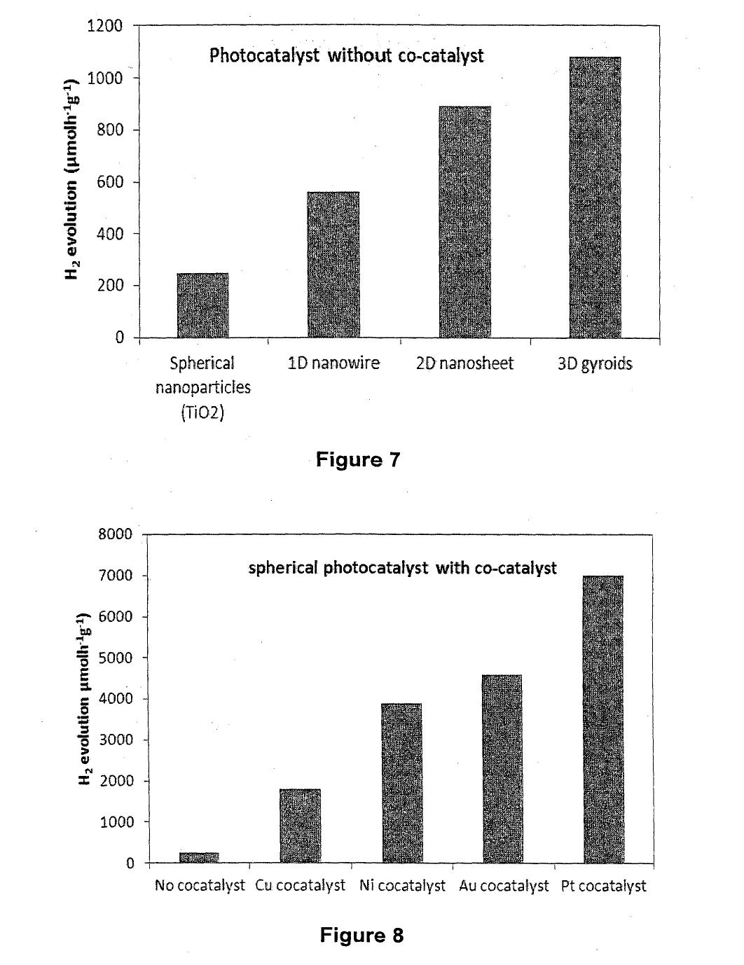

With reference to FIG. 7, the photocatalytic performance of one-dimensional nanowires without a co-catalyst, two-dimensional nanosheets without a co-catalyst, and three-dimensional gyroids without a co-catalyst was measured and compared with the photocatalytic performance of zero-dimensional nanoparticles and/or spherical nanoparticles. As shown in FIG. 7, the one-dimensional nanowires showed an improvement in photocatalytic performance of 2-3 times over the zero-dimensional nanoparticles and/or spherical nanoparticles. Also, the two-dimensional nanosheets showed an improvement in photocatalytic performance of 3-4 times over the zero-dimensional nanoparticles and/or spherical nanoparticles. Further, the three-dimensional gyroids showed an improvement in photocatalytic performance of 4-4.5 times over the zero-dimensional nanoparticles and/or spherical nanoparticles.

With reference to FIG. 8, the photocatalytic performance of various co-catalysts combined with a spherical photocatalyst was measured and compared to the photocatalytic performance of a spherical photocatalyst without a co-catalyst. As shown As shown in FIG. 8, photocatalysts combined with a co-catalyst showed an improvement in photocatalytic performance of 7-28 times over the photocatalyst without a co-catalyst. The co-catalysts measured include copper (Cu), nickel (Ni), gold (Au), and platinum (Pt). The photocatalyst combined with the platinum co-catalyst showing the largest improvement in photocatalytic performance.

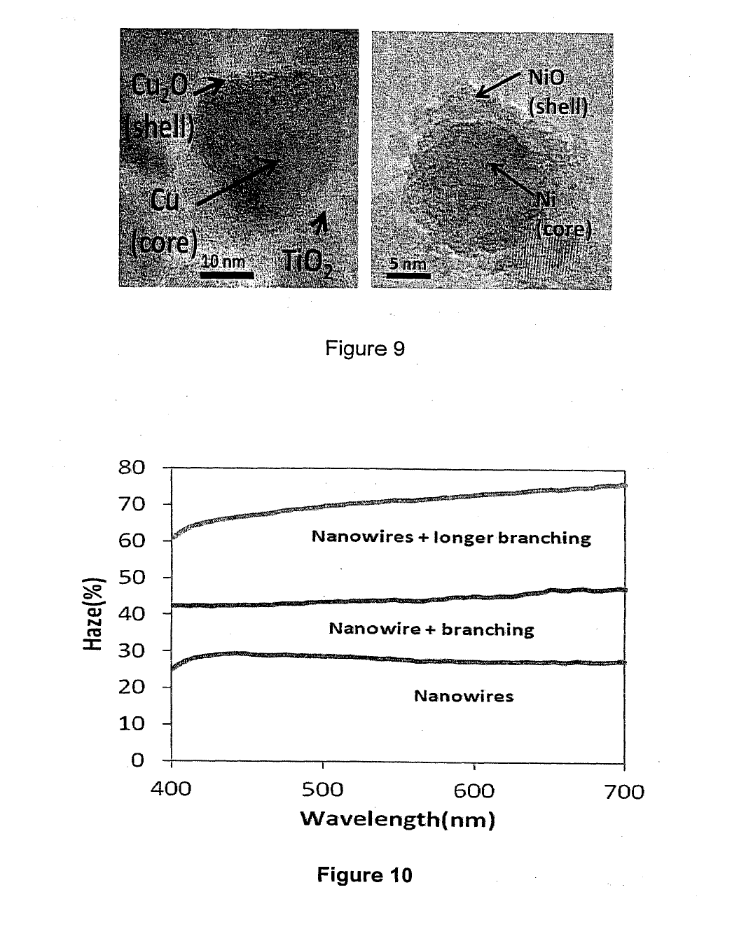

As shown in FIG. 9, the co-catalyst may have a core-shell structure. For example, a copper co-catalyst may comprise a copper (Cu) core with a copper (I) oxide (Cu₂O) shell. In the case of a nickel co-catalyst, the core-shell structure may comprise a nickel (Ni) core and a nickel (II) oxide (NiO) shell.

With reference to FIG. 10, the one-dimensional nanowires comprising branches have an enhanced visible light scattering capability for improved photon harvesting and/or improved visible light absorption.

The photocatalysts of the present invention may comprise Au—Ga203, Ag—Ga₂O₃, Ni—Ga₂O₃, Zn—Ga₂O₃, Ni—TiO₂, or Pt—ZnO. Other photocatalytic materials are also contemplated.

As discussed above, various dimensional photocatalyst nanostructures such as one-dimensional nanowire photocatalysts, two-dimensional nanosheet photocatalysts, and three-dimensional gyroid photocatalysts were surface engineered to construct improved photocatalysts having an enhanced photocatalytic reactivity and/or enhanced photocatalytic performance.

Surface and interface engineering was used to form photocatalysts having a one-dimensional nanowire structure, two-dimensional lamellar nanosheet structure, and three-dimensional interconnected matrix gyroid structure, which provide good electron transport due to a decrease in grain boundaries and/or decrease in defects of the single crystal phase and/or polycrystalline phase. For example, the decrease in defects of the single crystal phase of the one-dimensional nanowires may result in less recombination centres thereby leading to a decrease in electron-hole recombination. Also, the decrease in defects of the polycrystalline phase of the three-dimensional gyroids may result in less recombination centres thereby leading to a decrease in electron-hole recombination.

Other surface engineering of the one-dimensional nanowire photocatalysts, two-dimensional nanosheet photocatalysts, and three-dimensional gyroid photocatalysts includes the introduction of visible light photosensitization, light scatterers, and efficient charge transporter and separator co-catalysts.

In some photocatalytic water splitting applications, the photocatalyst described in the example embodiments can be directly applied e.g. as a suspension in water. However, it will be appreciated by a person skilled in the art that the photocatalyst can be applied as an attachment e.g. to a surface, and can be used in other applications.

It will be appreciated by a person skilled in the art that numerous variations and/or modifications may be made to the present invention as shown in the specific embodiments without departing from the spirit or scope of the invention as broadly described. The present embodiments are, therefore, to be considered in all respects to be illustrative and not restrictive.

1-40. (canceled)

41. A photocatalyst for water splitting, the photocatalyst comprising a nanocrystalline structure having a selected specific surface area and volume fraction of atoms located both on the surface and at the grain boundaries to provide an increase in the surface energy for enhancement of a photocatalytic reaction relative to spherical nanoparticles and/or zero-dimensional nanoparticles.

42. The photocatalyst as claimed in claim 41, wherein the structure is selected from the group consisting of
a structure comprising one or more one-dimensional nanowires,
a lamellar structure comprising two-dimensional nanosheets, and
a structure comprising a three-dimensional gyroid structure,

43. The photocatalyst as claimed in claim 41, wherein the photocatalyst has a specific surface area of greater than 70 m²/g, a pore volume of greater than 0.04 cm³/g, or a H₂ production capability of greater than 250 μmolh¹g⁻¹.

44. The photocatalyst as claimed in claim 41, wherein the photocatalyst exhibits an improvement in light absorption of at least 40% over spherical nanoparticles and/or zero-dimensional nanoparticles and an improvement in photocatalytic performance of at least 2 times over spherical nanoparticles and/or zero-dimensional nanoparticles.

45. The photocatalyst as claimed in claim 41, wherein the structure has a larger specific surface area and a higher volume fraction of atoms located both on the surface and at the grain boundaries compared to a spherical nanoparticle.

46. The photocatalyst as claimed in claim 42, wherein functionalized nanoparticles or functionalized branches are disposed on the one-dimensional nanowires.

47. The photocatalyst as claimed in claim 42, wherein said lamellar structure comprising two-dimensional nanosheets is intercalated with nanoparticles or nanorods, wherein the nanosheets comprise a metal oxide or graphene.

48. The photocatalyst as claimed in claim 41, wherein the photocatalyst is further configured to receive a co-catalyst for enhancement of the photocatalytic reaction, wherein the co-catalyst is selected from the group consisting of nanoparticles, nanorods and a core-shell structure comprising a lanthanide/transition metal core and a metal oxide shell.

49. A method for fabricating a nanocrystalline photocatalyst for water splitting, the method comprising the step of forming a nanocrystalline structure having a selected specific surface area and volume fraction of atoms located both on the surface and at the grain boundaries to provide an increase in the surface energy for enhancement of a photocatalytic reaction relative to spherical nanoparticles and/or zero-dimensional nanoparticles

50. The method as claimed in claim 49, wherein the structure is selected from the group consisting of
a structure comprising one or more one-dimensional nanowires,
a lamellar structure comprising two-dimensional nanosheets, and
a structure comprising a three-dimensional gyroid structure.

51. The method as claimed in claim 49, wherein the photocatalyst has a specific surface area of greater than 70 m²/g, a pore volume of greater than 0.04 cm³/g, or a H₂ production capability of greater than 250 μmolh⁻¹g⁻¹.

52. The method as claimed in claim 49, wherein the photocatalyst exhibits an improvement in light absorption of at least 40% over spherical nanoparticles and/or zero-dimensional nanoparticles and an improvement in photocatalytic performance of at least 2 times over spherical nanoparticles and/or zero-dimensional nanoparticles.

53. The method as claimed in claim 49, comprising forming the structure to have a larger specific surface area and a higher volume fraction of atoms located both on the surface and at the grain boundaries of the photocatalyst compared to a spherical nanoparticle.

54. The method as claimed in claim 50, wherein the one-dimensional nanowires are formed using a hydrothermal growth process.

55. The method as claimed in claim 50, further comprising disposing functionalized nanoparticles or functionalized branches on the one-dimensional nanowires.

56. The method as claimed in claim 55, wherein the functionalized nanoparticles are disposed on the one-dimensional nanowires by sputtering of a film and performing a dewetting process, and wherein the functionalized branches are disposed on the one-dimensional nanowires by spin coating of colloidal nanoparticles and performing a hydrothermal growth process.

57. The method as claimed in claim 50, wherein when the structure is a lamellar structure comprising two-dimensional nanosheets, the method further comprises forming the lamellar structure to comprise a lamellar structure comprising two-dimensional nanosheets intercalated with nanoparticles or nanorods, wherein the nanosheets comprise a metal oxide or graphene.

58. The method as claimed in claim 57, wherein a precursor of the nanoparticles is set at about 90-100° C. for the intercalation with the nanoparticles, and wherein a concentration of about 5.5 mmol or greater of metal acetate dihydrate is provided for the intercalation with the nanorods.

59. The method as claimed in claim 57, wherein the metal oxide nanosheet is synthesized using a hydrothermal process to form a colloidal suspension, and wherein the graphene nanosheet is synthesized from graphite powder using the Hummers method to form a colloidal suspension.

60. The method as claimed in claim 50, wherein the gyroid structure is formed by a process comprising mixing inorganic metal oxide precursors with a structure-directing agent.

61. The method as claimed in claim 49, further comprising adapting the photocatalyst to receive a co-catalyst for enhancement of the photocatalytic reaction, wherein the co-catalyst is selected from the group consisting of nanoparticles, nanorods and a core-shell structure comprising a lanthanide/transition metal core and a metal oxide shell.

62. The method as claimed in claim 61, wherein the core-shell co-catalyst is synthesized using precipitation and a hydrothermal process.

63. A water splitting method comprising using the photocatalyst as claimed in claim 41.
